(19) United States
(12) Patent Application Publication
(10) Pub. No.: US 2016/0132297 A1
(43) Pub. Date: May 12, 2016

(54) METHOD AND COMPUTER PROGRAM FOR GENERATING OR MANIPULATING SOURCE CODE

(71) Applicant: SMART RESEARCH LIMITED, Masterton (NZ)

(72) Inventor: Michael FERGUSON, Carterton (NZ)

(21) Appl. No.: 14/896,306

(22) PCT Filed: Jun. 10, 2014
(86) PCT No.: PCT/NZ2014/000112

§ 371 Date: Dec. 4, 2015

(30) Foreign Application Priority Data
Jun. 11, 2013 (NZ) 611812

(51) Int. Cl. G06F 9/44; G06F 17/24

(52) U.S. Cl. CPC G06F 8/34; G06F 17/245

(57) ABSTRACT

The invention relates to a computer-implemented method of generating or manipulating source code for a software development project. The computer-implemented method includes the steps of generating a map comprising a table having a plurality of cells arranged in one or more columns and one or more rows, populating a cell in the table with an attribute from a set of attributes, wherein the cell is populated either by a user inputting an attribute or, automatically, by an attribute generated from an existing source code, wherein a rule is applied to the attribute in the cell and the application of the rule to the attribute automatically generates or manipulates source code. The invention also relates to a computer program for generating or manipulating source code for a software development project, the computer program being configured to express algorithms in tabular form and apply one or more transformations against the algorithms.

This invention relates to a computer-implemented method of generating or manipulating source code for a software development project. The invention also relates to a computer program suitable for use in implementing such a method.

As used throughout the specification, the term “software development project” is intended to refer to any project for the creation, modification or analysis of computer software.

### BACKGROUND TO THE INVENTION

The traditional method of software development is a lengthy and time consuming process. This usually involves an expert in the subject matter of the software entering into a dialog with a software analyst. The analyst takes the findings and documents them into a map. The map is an unambiguous definition which a developer uses to write code. A tester then writes a test plan from the map to confirm that the code and the map are aligned.

One of the great challenges of software engineering is to find effective mechanisms for the evolutionary development and integration of software components. Separating intention (the basic operations and calculations to be performed) from coordination (the ways in which computations interact and cooperate) improves the flexibility and maintainability of software systems.

The object of this invention is to reduce the effort of developing software by eliminating the separate coding and testing steps required by the traditional software development lifecycle.

### SUMMARY OF THE INVENTION

According to a first aspect of the invention, there is provided a computer-implemented method of generating or manipulating source code for a software development project which includes the steps of generating a map comprising a table having a plurality of cells arranged in one or more columns and one or more rows, populating a cell in the table with an attribute from a set of attributes, wherein the cell is populated either by a user inputting an attribute or, automatically, by an attribute generated from an existing source code, wherein a rule is applied to the attribute in the cell and the application of the rule to the attribute automatically generates or manipulates source code.

A significant advantage of the method is that a software analyst or other user can discuss the map directly with an expert in the subject matter of the software being developed. The expert can suggest changes to the map which can then be made by the analyst or other user, for example, editing an attribute in the cell of the table and thereby changing the source code. Accordingly, there is no need for either a software developer or tester. This can result in substantial savings in terms of time and cost in the software development project.

The rule may be expressed in a cell of the table and a user may edit the rule and thereby change the source code.

A software system may be divided into a number of stages, each stage being expressed in tabular form as an attributed set. Each set may be expressed as a collection of rows in a table, each row of which involves one or more transformations on the set.

Sets may be joined together as an input to a new set. An attribute may be derived from attributes of sets, the results of a rule or the effect of a join between sets. The method may include associating rules which specify a type of join between related sets that are used to define a set. The method may also include defining a priority between related sets that are used to define a set.

The method may include defining a non-equal relationship between related sets that are used to define a set. The order of stages of sets within a software system may be derived from relationships between sets.

A staged process may be constructed from associated rules to define a computer program in a language or collection of languages for which rules have been defined. The staged process and language specific rules may be deconstructed from a computer program.

Language fragments may be reduced to rules which can be associated with a set or attribute. In this embodiment, rules may be embedded within rules. Rules may be associated with a language. A staged process may be associated with a rule. A rule may be associated with a type to apply common behaviour to a set of rules. Common terms within a rule may be substituted with sets and attributes aliased during association. Rules may be compared by name to discover variations of use for a common name. Rules may be compared by language fragment to identify common usage patterns to allow for conformation of rules.

According to a second aspect of the invention, there is provided a computer program for generating or manipulating source code for a software development project, the computer program being configured to express algorithms in tabular form and apply one or more transformations against the algorithms

A transformation may comprise one or more of the following: decompiling existing code into tabular form; expressing an algorithm as a diagram of relationships; compiling a table into code; comparing patterns to identify common processing; or rendering code in any language from tabular form.

The computer program may be configured to implement the method of the first aspect of the invention referred to above.

### DETAILED DESCRIPTION OF THE INVENTION

A preferred embodiment of the method and computer program will now be described, by way of example only, with reference to the accompanying drawings in which:

FIG. 1 is a diagram illustrating the process involved for traditional software development compared with the invention.

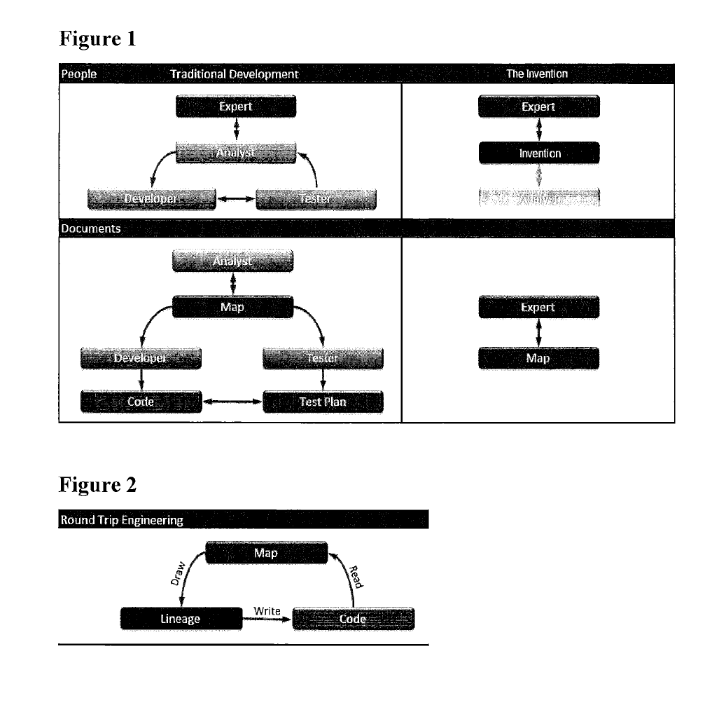

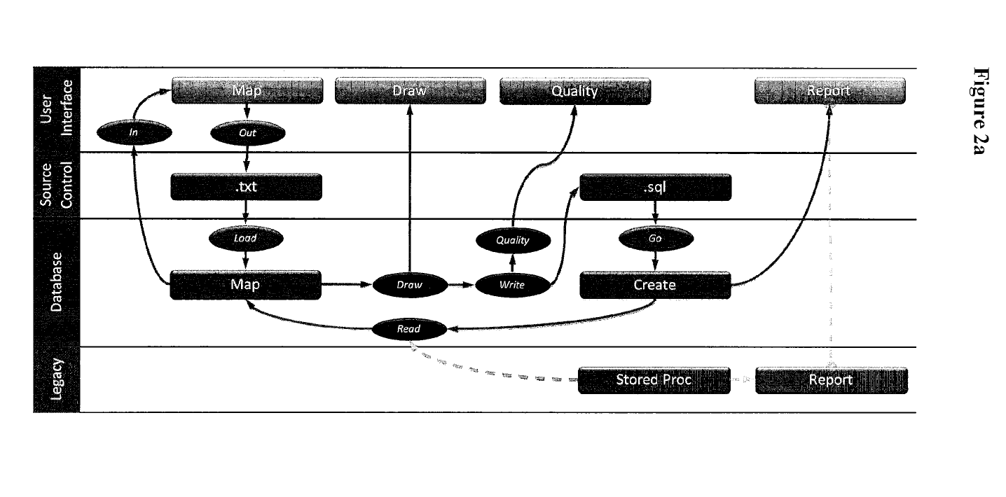

FIG. 2 is a diagram illustrating round trip engineering.

FIG. 2a is a diagram illustrating how round trip engineering would be implemented onto a physical platform.

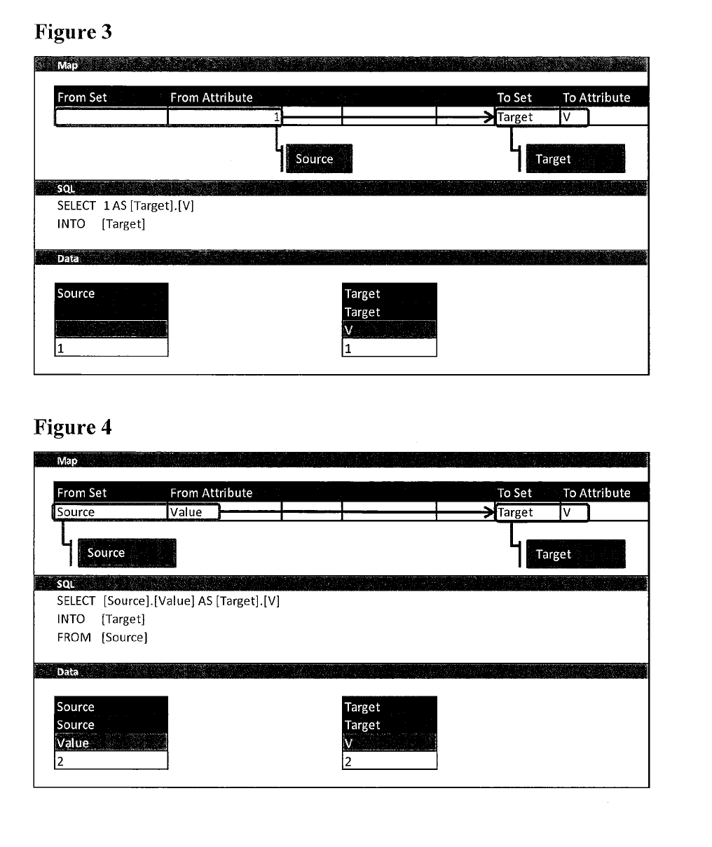

FIG. 3 is a diagram illustrating the map, source code and data for a literal value assigned to a target attribute.

FIG. 4 is a diagram illustrating the map, source code and data for a source attribute assigned to a target attribute.

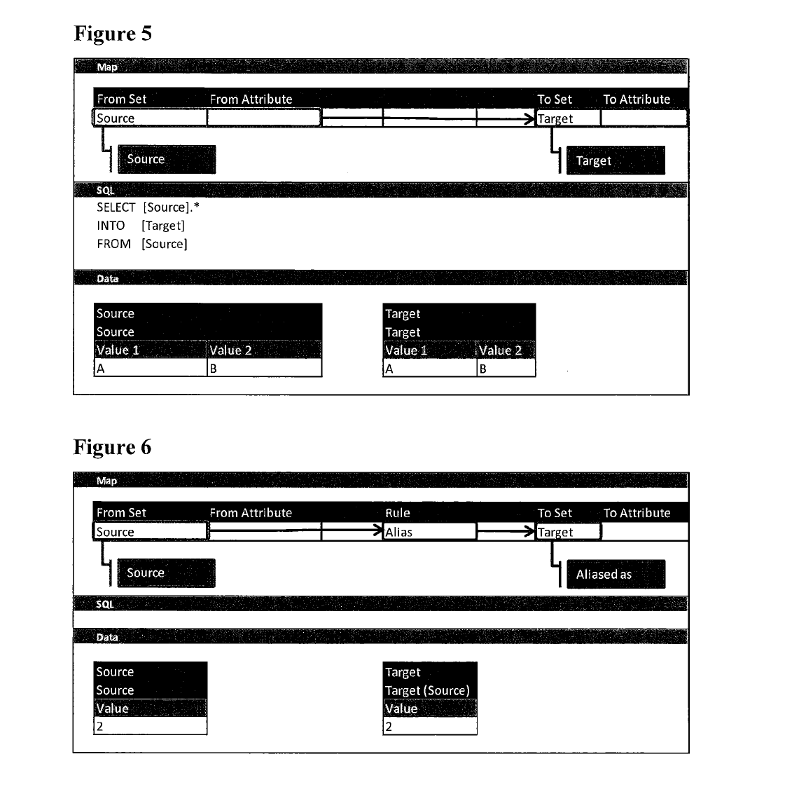

FIG. 5 is a diagram illustrating the map, source code and data for when no attribute is defined from a set and all attributes are implied.

FIG. 6 is a diagram illustrating the map, source code and data for a set alias.

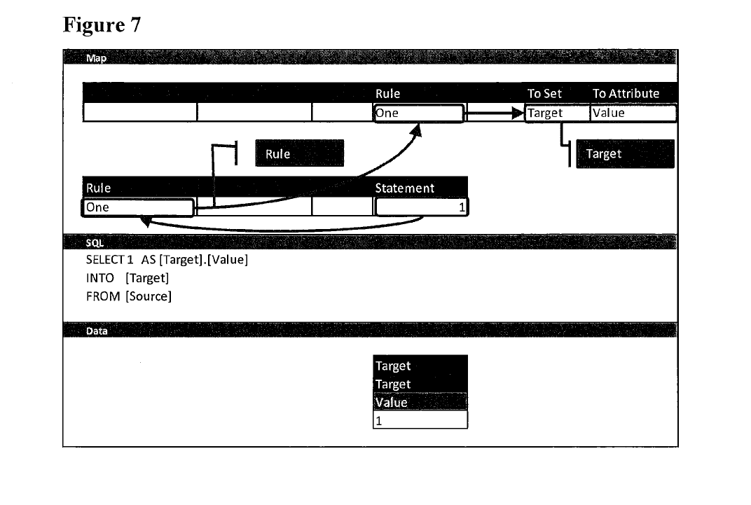

FIG. 7 is a diagram illustrating the map, source code and data for a rule reference which assigns a statement to a rule name.

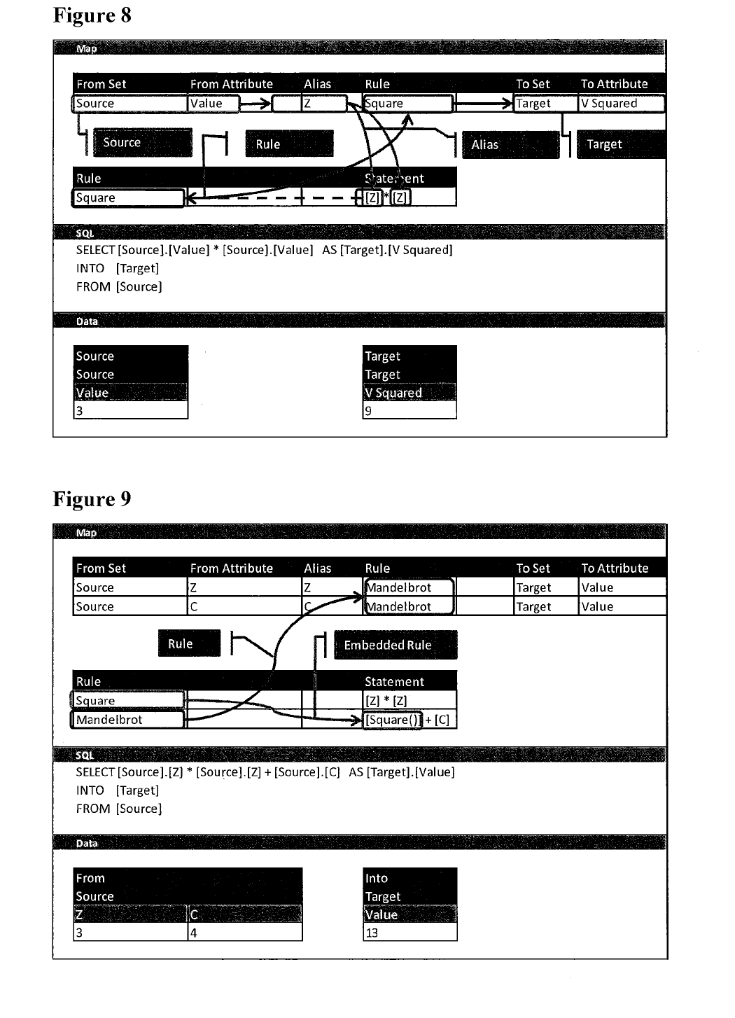

FIG. 8 is a diagram illustrating the map, source code and data for a rule alias.

FIG. 9 is a diagram illustrating the map, source code and data for an embedded rule.

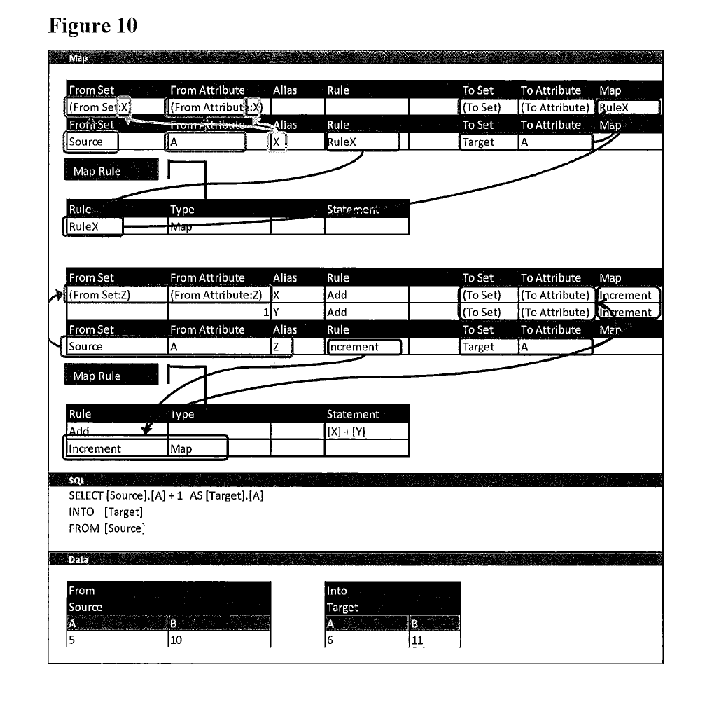

FIG. 10 is a diagram illustrating the map, source code and data for a map rule.

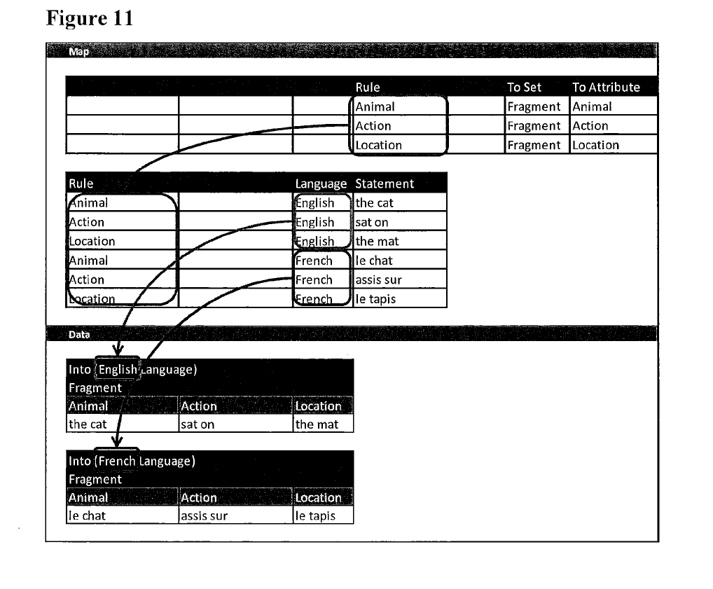

FIG. 11 is a diagram illustrating the map and data for a language substitution.

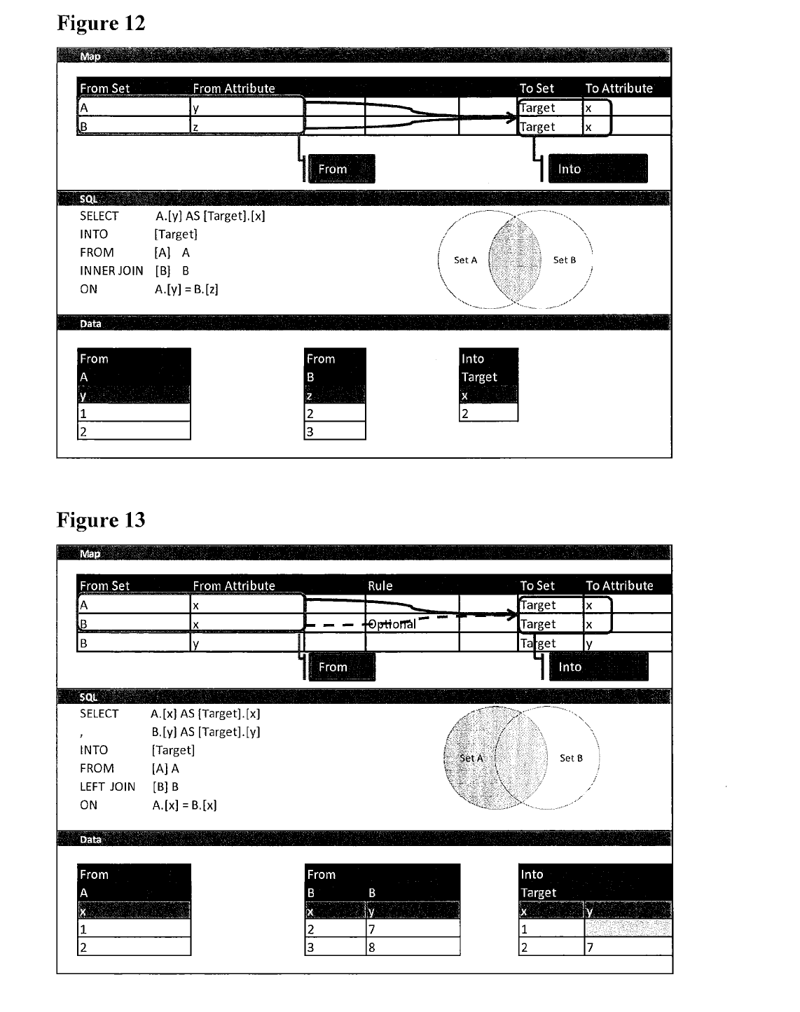

FIG. 12 is a diagram illustrating the map, source code and data for an inner join.

FIG. 13 is a diagram illustrating the map, source code and data for an optional (outer) join.

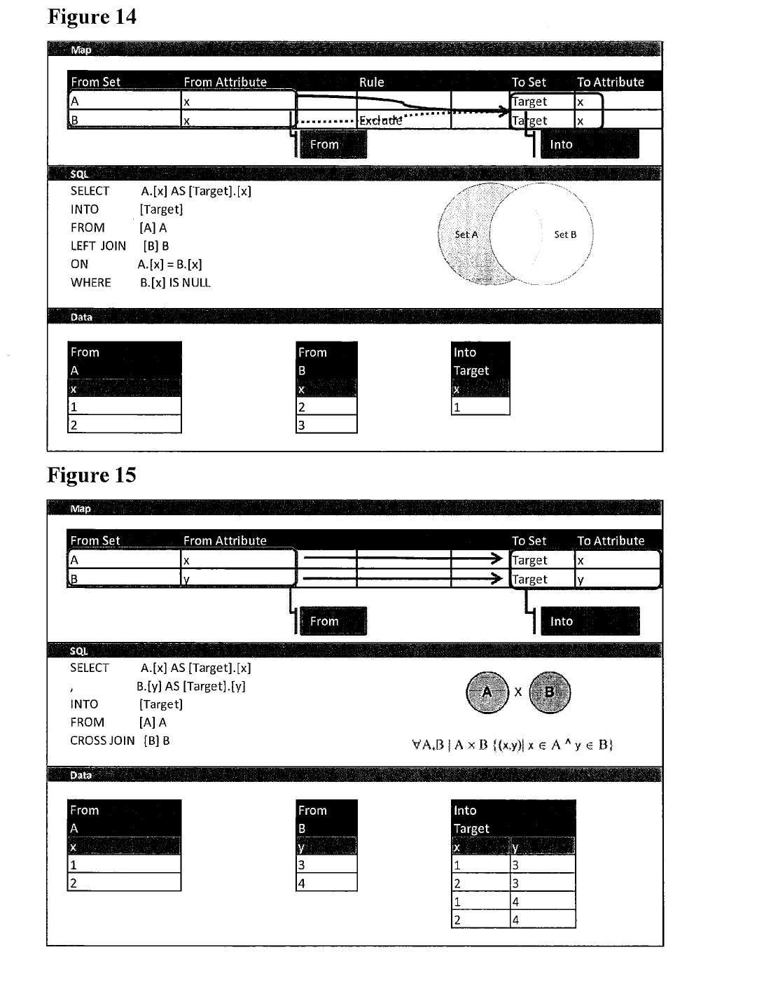

FIG. 14 is a diagram illustrating the map, source code and data for an exclude join.

FIG. 15 is a diagram illustrating the map, source code and data for a cross join.

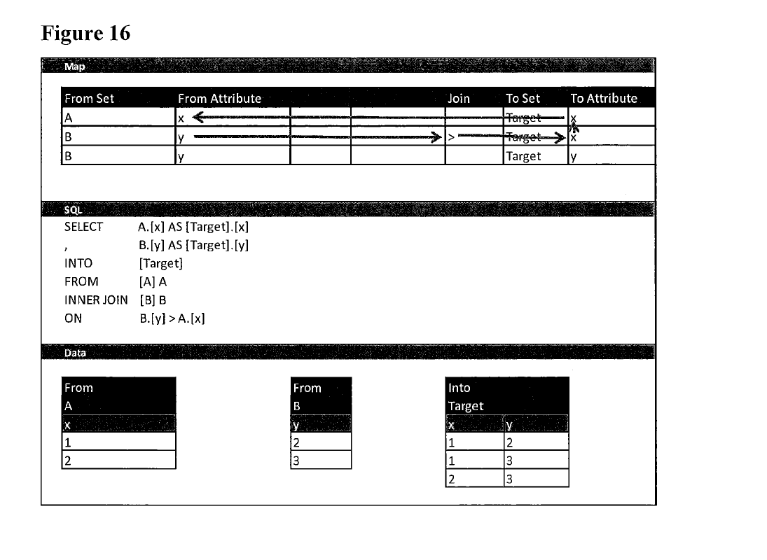

FIG. 16 is a diagram illustrating the map, source code and data for a non equal join.

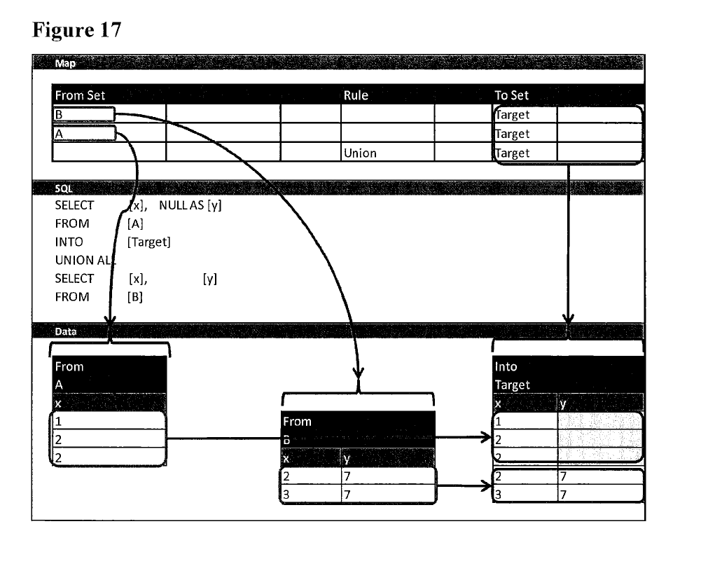

FIG. 17 is a diagram illustrating the map, source code and data for a union in which duplicate records are retained in the target set.

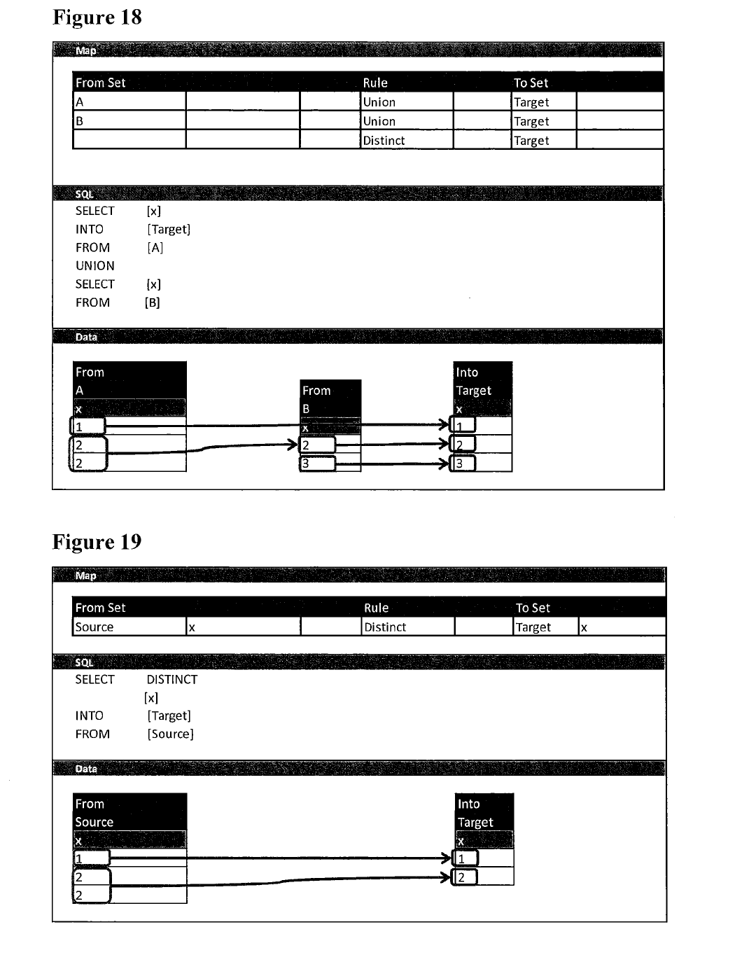

FIG. 18 is a diagram illustrating the map, source code and data for a union in which duplicate records are eliminated from the target set.

FIG. 19 is a diagram illustrating the map, source code and data for a limit join rule specifying a restriction on the members of a set.

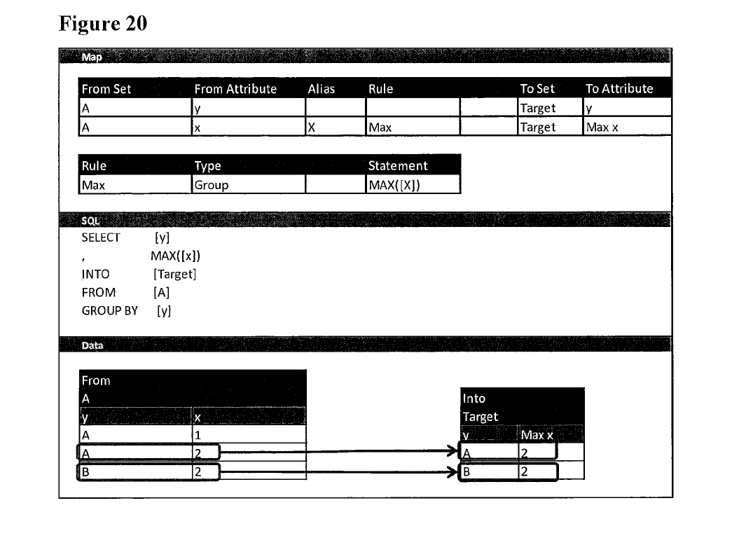

FIG. 20 is a diagram illustrating the map, source code and data for a rule associated with the group type.

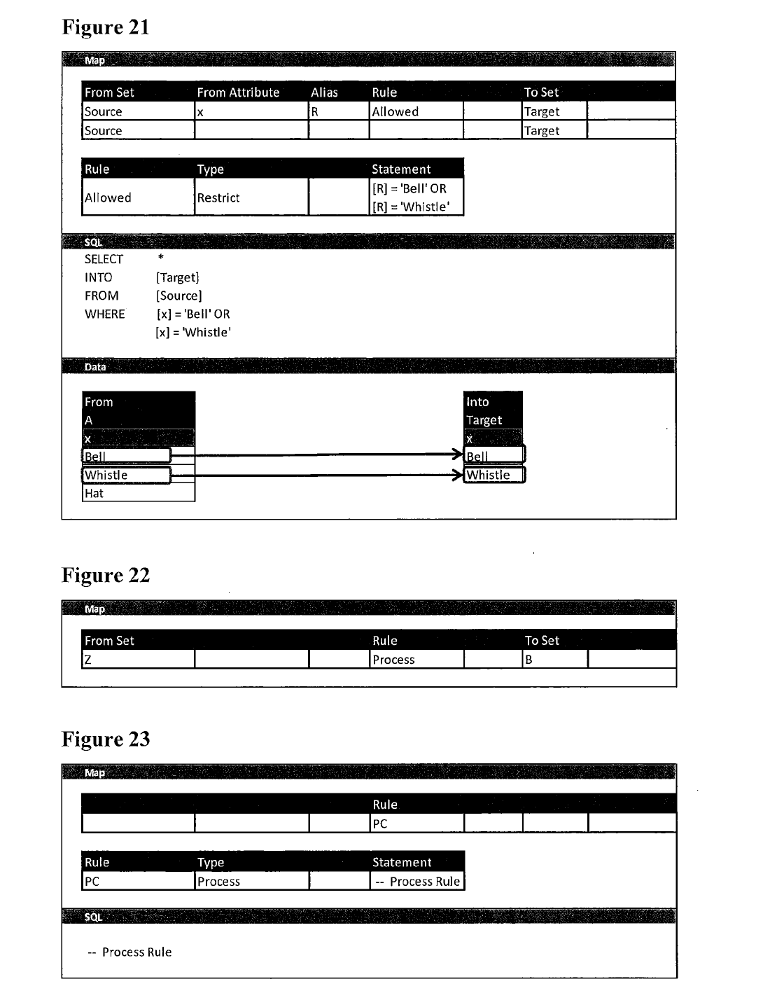

FIG. 21 is a diagram illustrating the map, source code and data for a restriction.

FIG. 22 is a diagram illustrating the map for a process precedent.

FIG. 23 is a diagram illustrating the map and source code for a process rule.

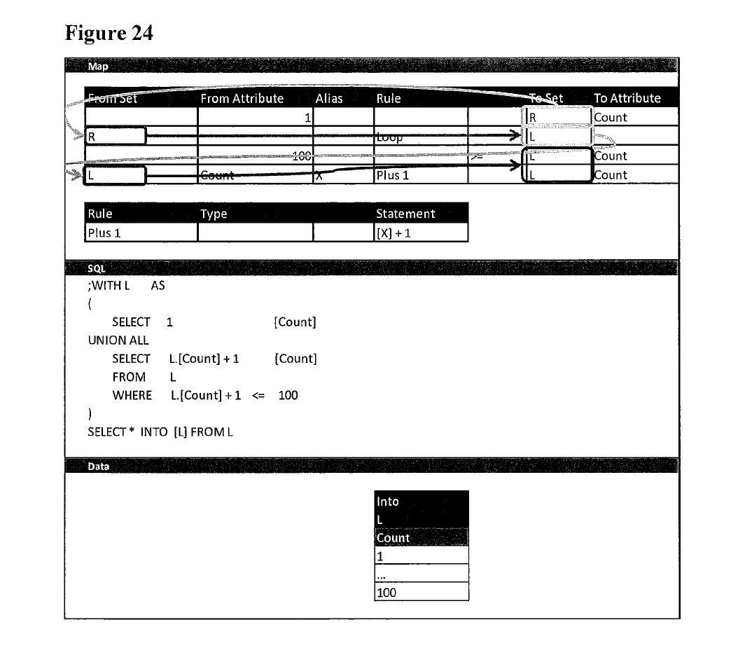

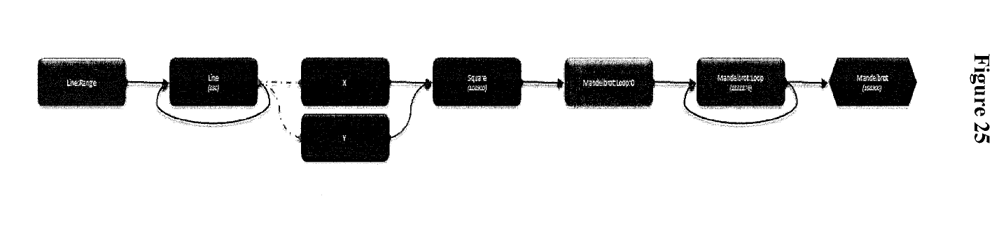

FIG. 24 is a diagram illustrating the map, source code and data for a loop

FIG. 25 is a diagram illustrating a Mandelbrot set process flow as defined by a map.

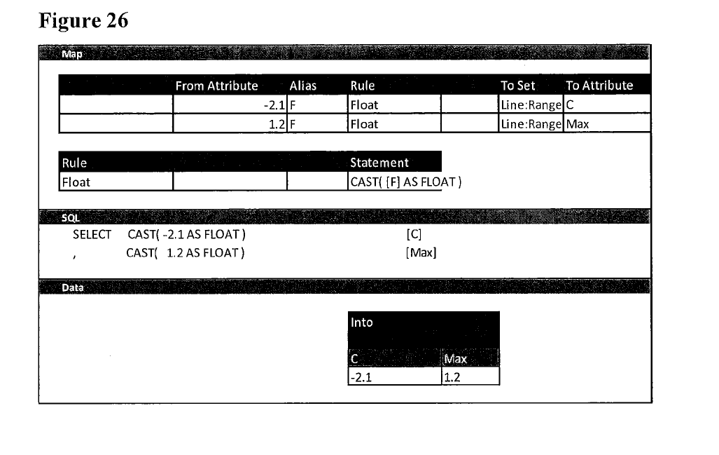

FIG. 26 is a diagram illustrating the map, source code and data for the set [Line:Range].

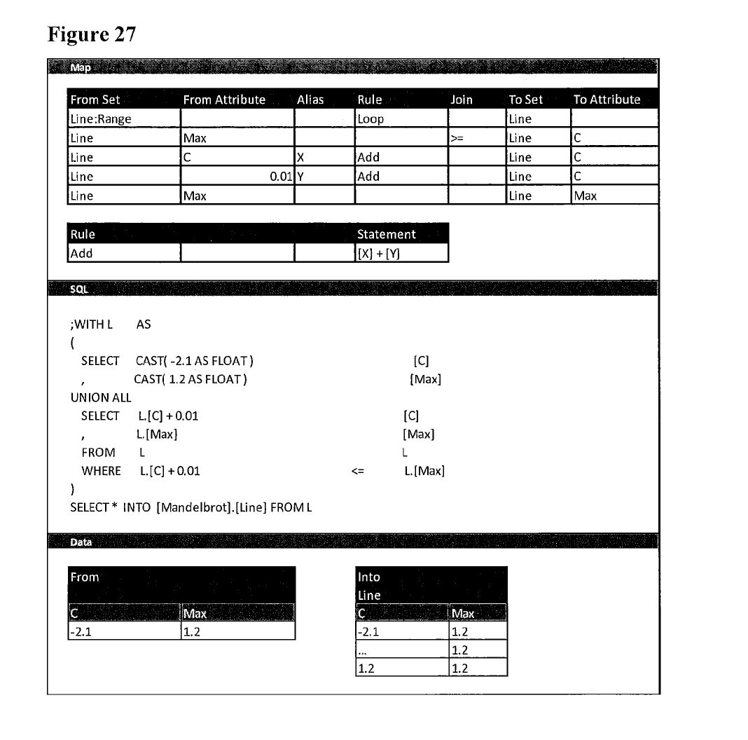

FIG. 27 is a diagram illustrating the map, source code and data for the set [L].

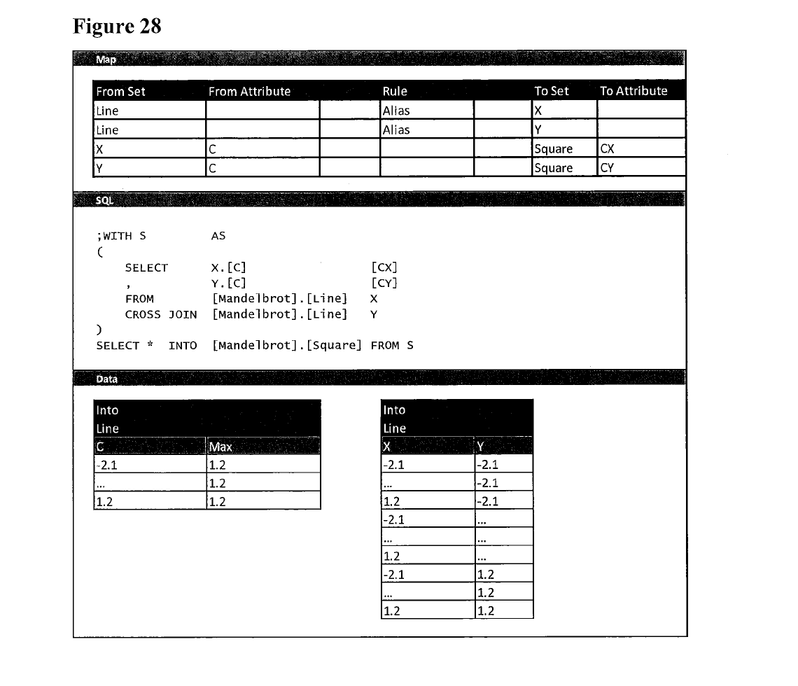

FIG. 28 is a diagram illustrating the map, source code and data for the set [Square].

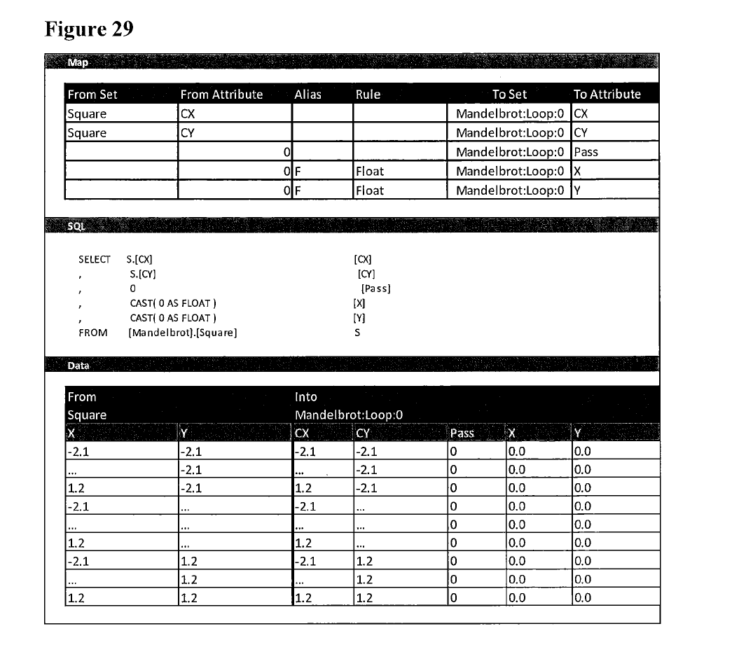

FIG. 29 is a diagram illustrating the map, source code and data for the set [Mandelbrot:Loop:0].

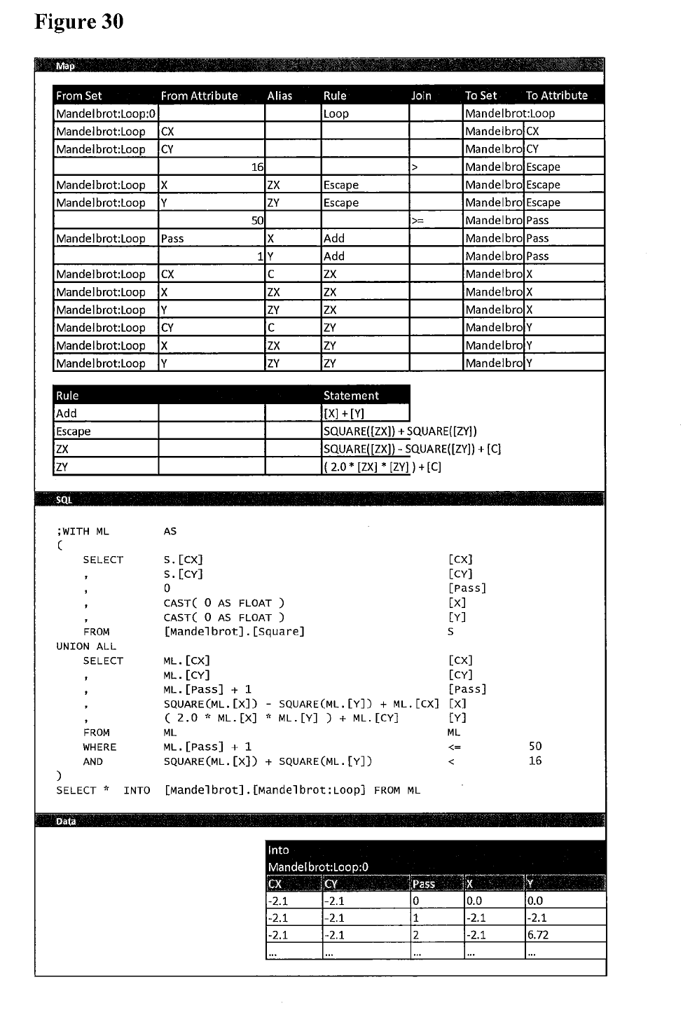

FIG. 30 is a diagram illustrating the map, source code and data for the set [Mandelbrot:Loop].

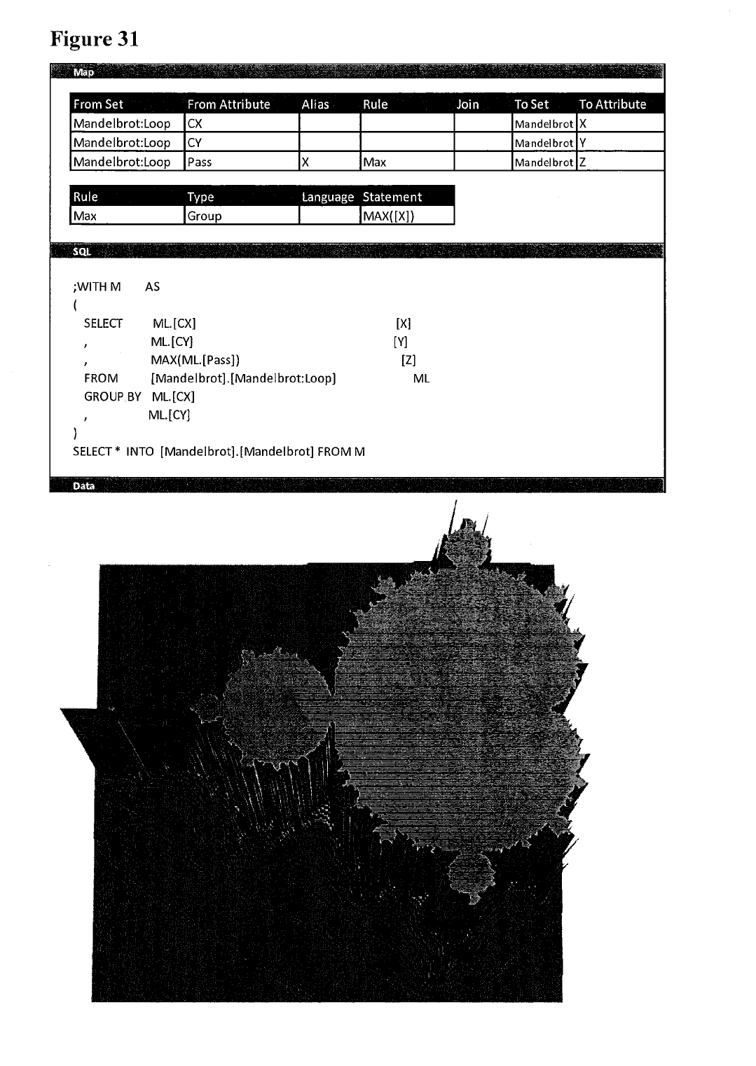

FIG. 31 is a diagram illustrating the map, source code and data for the set [Mandelbrot].

There are two aspects to the invention. The first is a computer-implemented method for defining the intention of systems using maps and rules expressed as tables. The second is a computer program which is configured to ensure that maps, lineage diagrams and code are always aligned.

In a first aspect, the invention relates to a computer-implemented method of generating or manipulating source code for a software development project which includes the steps of generating a map comprising a table having a plurality of cells arranged in one or more columns and one or more rows, populating a cell in the table with an attribute from a set of attributes, wherein the cell is populated either by a user inputting an attribute or, automatically, by an attribute generated from an existing source code, wherein a rule is applied to the attribute in the cell and the application of the rule to the attribute automatically generates or manipulates source code.

In a second aspect, the invention relates to a computer program for generating or manipulating source code for a software development project, the computer program being configured to express algorithms in tabular form and apply one or more transformations against the algorithms.

As illustrated in FIG. 1, the method of the invention streamlines the traditional process of software development significantly. Using the method a software analyst can interactively build a map in consultation with an expert in the subject matter of the software. Since there is no coding or test cycle the results of each step are verified with the expert as they are defined. A map produced by the method can be modified by experts with analysis skills directly without the need for an analyst, developer or tester.

The use of the method of mapping allows for automations to reduce the manual effort to produce and maintain different abstractions of the data map. Examples of these abstractions would be lineage diagrams, attribute mappings, algorithms, quality tests or code.

Maps produced by the method can be developed by analysts in close consultation with experts. Immediate access to the results of the mappings results in a highly iterative approach to problem solving. This allows for an interactive, result driven mapping effort and an observational approach to transformation development which results in early quality acceptance.

By using a read process, the maps can be derived from existing functions, algorithms or code. This allows for a visual representation of system flow produced via a draw process. Maps generated by reading source code can be used to rewrite the code whilst preserving the intent of the source code.

The maps are language agnostic, code generated from maps can be rendered in any programming language that is supported by a write process. The computer program allows for systems to be read from any language supported by a read process and written in any language supported by a write process.

The maps and rules are completely self-contained. No other artifacts are required to render any process in a repeatable and complete form in any language.

Traditional software development methods result in code and specifications diverging as time constraints result in the implementation moving ahead of the specification. When analysis of an existing process is required, the code must be understood in order to know what is actually implemented. Code is difficult to analyse because it cannot be sorted or filtered with the rules, data sets and attributes being embedded within language specific notation. This results in the actual implementation of business rules being locked into code which requires an expert in the coding language to interpret. Maps produced according to the method are held as tables which are completely transparent and allow for sorting and filtering. Such maps are simple to interpret and unambiguous.

The maps for a software system can be cross-referenced internally or with other maps to expose common patterns. Using the principal of reflection, irregularities and errors in a system can be identified and reduced through observation. A library of common rules and mappings for systems can be accumulated as systems are defined in maps which reduce the overall system complexity. This allows systems to be merged together and rules rationalised to allow for rapid integration of systems.

A collection of system terms and patterns will emerge from the process of cross-referencing systems resulting in a natural hierarchy of common maps and rules. These common terms can be reused providing increased flexibility and agility to the system. By implementing pattern matching algorithms the terms used can be reduced and further patterns derived from the result. In this way a fractal representation of any system can be produced where self-similar patterns can be seen at any level of the system.

The result of rewriting is that systems are defined using common patterns with collections of common patterns being arranged into common patterns recursively. Common patterns can then be mapped to specific effect. An effect list can be built as the output of a reduction process. The effects can be matched against external factors allowing the method of the invention to select appropriate patterns as a reaction to changes in its inputs. This allows for automated rewriting of systems. Since the invention itself is a system it can therefore modify itself

Self-modification is a trait of artificial intelligence systems. Maps can be rendered as a network of sets, attributes, joins and rules with the most frequently used elements having the most connections. This means that maps produced by the method are an implementation of a neural network. The method is a framework for the implementation of a neural network.

By automating the reading of systems a library of connections can be made. By recognising common patterns in the library of connections an integration and simplification of systems is possible. Analysis processes can be performed on the resulting integrated system to identify closely matching patterns and highlight inconsistencies. Inconsistencies can be matched against a context based rules library with the exceptions conforming to a common pattern. The system can then be rewritten using the new pattern. In this way systems can be automatically merged, it is envisaged that a subject matter expert would tune and refine the context based rules based upon observation and that this process itself would become more automated once a repeatable process for observation had itself been mapped.

The ultimate objective for the method of the invention is for all systems to be mapped into a single conformed network with the most common patterns being central. Variations on common patterns radiate out from the center, which in turn have other variations radiating from them. An end point with no variations represents a unique individual pattern. The more conformed a system or parts of a system is to the center of the network the easier the system will be to effect change with other related systems. This can be visualised as a tree structure such as a Lindemayer fractal. The root of the tree being represented by the primitives with branches diverging until a leaf is reached which represents a single occurrence of pattern.

Set theory can be used as a foundation from which nearly all of mathematics can be derived. The method of the invention defines any problem in terms of set theory using a map to describe relationships between sets. The problem is broken down into a series of stages with a set being the product of each stage. Transformations occur between stages. Transformations in the map allow for intersections and rename operations. Complex transformations are defined through rules.

Each map exists within a schema which is a collection of unique sets and rules. Schemas can be associated with and called from other schemas. A schema is a namespace where a named set can only be referred to once. The result of performing a schema is a populated collection of sets according to the map associated with the schema. Schema and map names are interchangeable allowing for flexibility by association or version.

The map is defined as a table of from/to relationships between sets. The start and end sets and the flow between sets are derived from the relationships. No explicit sequence is defined with the order of operations being derived from the relationships within the map. Relationships can be ‘drawn’ as a lineage diagram or ‘written’ in a programming language. A ‘read’ operation can be applied to an existing algorithm to derive the sets and relationships and convert them into a map. A ‘quality’ operation can be applied to a map to find inconsistencies within the map.

An algorithm is an effective method expressed as a finite list of well-defined instructions for calculating a function. Starting from an initial state and initial input (perhaps empty) the instructions describe a computation that, when executed, will proceed through a finite number of well-defined successive states, eventually producing output and terminating at a final ending state.

In computer systems, an algorithm is basically an instance of logic written in software by software developers to be effective for the intended “target” computer(s), in order for the target machines to produce output from given input (perhaps empty).

The computer program according to the invention describes algorithms and uses language specific rules to allow the algorithms to be rendered as software in the required language. A map can also be expressed in set theory algebra or relational algebra. The invention can be considered as a logical computer abstraction of any programming language.

### Round Trip Engineering (RTE)

As shown in FIG. 2, the maps provide a method for automating round trip engineering. The method of the invention can also be used to provide a method for forward engineering (creating software from maps), reverse engineering (creating maps from existing software), and reengineering (refactoring existing software). These processes can be defined using the maps or defined using any other algorithmic method including but not limited to relational algebra, database queries or procedural code.

The method of the invention enables the synchronisation of systems by updating each system to reflect changes made to the other systems. This is achieved through use of a common rule library, where a single term describes a more complex expression. A rule can be referred to in multiple places in the map with the expression of that rule being defined once. Each expression of a rule can be changed without change to the map. The same rule can be implemented differently depending upon the language that the map is to be rendered in.

Round trip engineering (RTE) allows existing code to be read into maps which in turn can be drawn and re-written as code. By using these aspects executable code is available after every change in the map.

The following RTE components are computations that can be expressed using the computer program of the invention. These components can be performed by hand or hand written as algorithms or expressed as maps for rewriting as code.

### Draw

This process takes the map set relationships and derives the end to end lineage for the schema. Sets which only appear as a [From Set] are starting sets; those which only appear as [To Set] are end sets. Sets that are both [From Set] and [To Set] are mid-stage sets. The order of the stages is calculated using a logistic algorithm which provides lineage, and groups the sets by close relations. It is possible to encounter recursion within relationships and these are terminated as they occur. Where a circular relationship exists the diagram is weighted in the direction of the set with the most direct relationships.

An implementation of a draw process would trace through the relationships between sets from all start and end points. A bi-directional trace is performed on any remaining sets that were not picked up by the first trace. The traces are then ranked to find the correct position for each set within the lineage. Recursive relationships are dropped as soon as they occur to prevent infinite recursion.

### Write

This process writes set creation stages in order of the lineage derived from the draw process. Where rules are defined these are substituted in code at attribute or set level.

Maps are compiled into a programming language using a write process. A write process produces code to create the equivalent set creation statement for each target set in a specific programming language. The set creation statement is written so that, given specified source sets, a target set will be populated when the statement is executed. The standard defined in the rule defines the standard of the generated code. This means that different standards can be implemented for each language supported.

The statement is broken down by the map into a collection of primitives. Rules are referenced within the map to provide specific code fragments. The collection of fragments resolves to a contiguous collection of code.

Maps can be written which generate rows in a table that equate to lines of code. These lines of code can be sorted into execution order. This code sequence represents a procedure which in turn can be compiled against a target language compiler. This allows the invention to be used as a pre-compiler where the code is expressed as maps which can then be converted into any language for which a write process has been written. The Read, Write, Draw and Quality processes can be expressed with code written using this technique.

An example write process would translate a map into SQL code. Code is sliced into sections which are rendered according to the map and rules. Examples of sections are procedure wrappers, set wrappers, select statements, join statements and processes. The sections are then concatenated in order to allow a render of the code.

### Read

This is the process of de-compiling code into map and rule tables. Relationships are defined based upon the intersections described in the code and the position of code fragments relative to identified sets and rules within the code. Attribute transformations are derived and abstracted so that common patterns can be detected. This allows a developer to make changes to code and for the computer program to absorb those changes into its map. Read can be extended to read code written in different styles or languages. The read process is heavily dependent upon standards based code with variations on standards requiring special parsing rules to handle them. Code written in a set driven language is easily translated to the method of the invention. Procedural languages which utilise loops, variables and branches are more challenging since these concepts do not translate directly to left to right parallel set transformations.

The read process performs the reverse of the write process by de-fragmenting the code into common patterns where the variables are expressed as sets and attributes. It may be that the read process will resolve to a map that will be written differently to the original code.

The collection of fragments maintains the intent of the original code whilst deriving sets and attributes from known set and attribute definitions for the coding language. Attribute rules are associated with attributes within the map. Fragments between set definitions that do not resolve to sets are transformed to process rules. The order of execution is maintained through relationships.

### Quality

The quality process performs checks upon the map and rules to identify bad forms. The write process will always resolve a map, where the invention has an irregular primitive it will generate a quality entry. The intent with the write process is that it always produces executable code. If an exception is identified then the quality report will highlight the exceptions. Classes of exceptions are: warnings, which are bad forms where a correct form can be assumed; errors, which are bad forms where no assumption as to intent can be made; and information, where correct form is assumed but perhaps an unintentional effect was introduced by correction.

### Self-Modification

The mapping method of the invention represents algorithms. Computer programs are algorithms which can be represented by the method. It follows then, that the process of compiling maps into code can be expressed by an algorithm which can be expressed as a map. The process of decompiling code into maps can equally be expressed as a map.

A map is a data set that can be processed by a map and transformed for a purpose. This may be to simplify, correct, update or any other purpose. The implication of this is that the invention is capable of changing itself based upon a set of conditions which can be defined by further maps. The ability to read an environment and change behavior to fit the environment is a trait of learning systems. It is conceivable that the invention will be able to try an array of strategies within an environment and select the most successful outcome based upon expected results. This would enable the invention to evolve a map that best fits an environment through cause and effect.

### Map Definition

Central to the invention is the concept of a map. This is a self-contained problem solving method that consists of a table of 7 columns: From Set; From Attribute; Alias; Rule; Join; To Set; and To Attribute.

Term rewriting is implemented using rules. The rule name defines the term. The rule may be expressed as the equivalent statement in any language. A rule can be used multiple places within a map. The rule type allows rules to be grouped together for special treatments.

Terms are represented in a language-neutral form, so that they can be exchanged between tools that are implemented in different languages.

### Association

Sets are defined by the [Set] name and [Attribute]'s within the set. In a map a set is referenced [From] to create a new set [To]. A set can appear as a [From Set] or [To Set] or both. When multiple sets are referenced into a new set then a join is implied between the contributing sets. The literal set contains fixed terms where the attribute name represents the value. The literal set is defined by an attribute value that has no set defined. Literals are used to define fixed values such as numbers or text.

### Joins

Where single a [To Attribute] for a set has multiple sources then an intersection join is assumed on that attribute. The [From Attribute]'s are presumed to be equivalent if they contribute to the same [To Attribute] of a set. If a non-equivalent join is required then a join operator (<, >, >=, <=, <>, like, not like, etc.) is defined.

### Rules

Rules are used to encapsulate a transformation or group of transformations into a term. Whenever a term (rule) is used in the map the transformations may be substituted. A rule can be a code fragment or a map.

### Code Fragment Rules

A code fragment rule is an instruction of any complexity that can be expressed in any programming language. Where attributes that are expressed in a map are required in the rule then the attributes are substituted for an alias in the rule. Code is assembled from rules using reverse substitution where a rule name is substituted for a code fragment within any map or rule that references the rule.

### Map Rules

A map can also be referenced as a rule. Mapping rules are collected under a map name. Input sets and output sets are substituted through an alias. The resolved mappings are then inserted into the target map as a sub map. A map under a named map can be called by itself or as part of a sequence of maps or referenced multiple times in a parent map as a sub map. Circular references are eliminated when they first occur.

### Rule Types

A rule can have a type. This is an indicator for special treatment. When maps are transformed to code using a write process the type is used to determine the correct syntax. The following types may be used: (i) group—indicates that this is an aggregation. The grain of the aggregation is dictated by the other attributes in the set which are not related to a group type rule; (ii) process—is used for sets that require non set related processes. This could encapsulate a series of functions or processes, or a single operation, such as defining a constraint; (iii) limit—is used to eliminate elements of the set such as distinct to de-duplicate entries or top 10; and (iv) substitution—allows the rule to be resolved when executed but acts as an substitution variable in any scripts that are generated.

### Process

Process is used to define flow within a collection of related sets. This can be used to implement self-referencing sets, recursion and branching. Procedural constructs that cannot be easily converted to the parallel equivalent can be implemented using process primitives. Entire systems or parts of systems can be embedded within a process where a system has not been abstracted into primitives, where an iterative approach to system conversion is being performed.

### Primitives

Primitives are the lowest level definitions of a mapping business process that have an equivalent in set theory, relational algebra, parallel code, procedural code or any algorithmic method. Multiple primitives of the same or different types can be grouped together within a map to define increasingly complex statements into multiple target sets. A collection of sets will define systems which have an equivalent in programming systems, business processes, algorithmic solutions or any process that can be described using set theory.

### Example 1

### Assignment Primitives

Set and attribute primitives represent set transformations between a source and target set. A target set is the single definition of that set within a system. A target may be referenced as a source set elsewhere within a map.

### Example 1.a

### Literal Value Assigned to Target Attribute

FIG. 3 illustrates an example of the simplest primitive where a literal value is associated to an attribute of a set. The literal set is a nameless implied set that contains literal values, where the attribute represents an actual value instead of a label containing values as in named sets. The literal set contains one instance of all actual values (e.g. all colours, all words, all numbers, nothing). The literal set cannot be a target.

### Example 1.b

### Source Attribute Assigned to Target Attribute

As shown in FIG. 4, an attribute from a set can be assigned to an attribute of a different set. All members of the source set are assigned to the target set. The name of the target set and the target attribute are defined as part of the assignment. If either a source attribute or a target attribute name is missing then the attribute name on the opposite side is implied.

### Example 1.c

### Inheritance

As illustrated in FIG. 5, when no attribute is defined from a set then all attributes are implied. Attributes from the source set along with their members are populated into the target set. An attribute cannot be referenced from a target set that was not a member of the source set that the target was inherited from.

### Example 1.d

### Set Alias

As shown in FIG. 6, a set alias associates the target set and attribute with the source set and attribute. The target set is not a populated set but a reference to the aliased source set. Any reference to the alias of a source set will resolve to the source set.

### Example 2

### Reduction Primitives

Rules are a method of associating statements with labels so that references to the label are substituted with the statement when a map is resolved. Rules can be used multiple times for different target attributes or referenced multiple times for a single attribute where multiple sources feed into the rule. Rules may be of any complexity and may contain references to other rules. Rules may be expressed in multiple languages and will resolve a different statement for each language defined.

### Example 2.a

### Rule

FIG. 7 shows a simple rule reference which assigns a statement to a rule name. The rule name can be associated with a target attribute so that the target attribute takes the value of the rules statement.

### Example 2.b

### Rule Alias

As shown in FIG. 8, a rule can contain an alias reference. An alias is associated with a source value in a map and referenced within a rule. When a rule is resolved the source set or attribute is substituted for the reference within the rule for that instance of the target set or attribute. An alias can be distinguished from terms for which no substitution is required through use of delimiters such as square brackets e.g. [alias]. If no source value is aliased to a statement label then the alias name remains within the statement.

### Example 2.c

### Embedded Rule

FIG. 9 illustrates that rules can be embedded within rules. This allows for complex rules with multiple occurrences of the same statement to be reduced further. This method of reduction can be applied to groups of named rules allowing an indefinite amount of embedding. An embedded rule can be implied by use of an alias with a function postfix or other indicator, e.g. [rule( )].

A rule can be referenced multiple times within another rule, e.g. [rule(X=Y)]. Aliases passed to the rule via a map can be associated with different aliases within an embedded rule. This is shown by associating aliases within a rule reference. Order of association is unimportant. Self-referenced Aliases are redundant.

### Example 2.d

### Map Rule

As shown in FIG. 10, map rules are a reduction method that allows maps to be simplified into rule names that can be used in maps which in turn can be simplified as map rules. Map rule reduction can be performed an indefinite number of iterations. A collection of mappings can be associated with a rule name. When the rule is used in a map the underlying mappings are substituted in the map that has referenced the rule. Where substitution is required in the map a combination of from set/attribute and alias can be used to link the calling map from attributes to the map rule from attributes. No alias is required on the to set/attribute since an instance of a rule can only have one target.

### Example 2.e

### Language Substitution

FIG. 11 illustrates that rules can be associated with target sets and resolve to statements in a language. Statements can be specified in different languages using the language attribute associated with a rule. Each rule may be rendered multiple languages. A rule rendered in multiple languages does not have to equate to a similar meaning across languages.

### Example 3

### Join Primitives

### Example 3.a

### Join Association

When multiple source sets are inputs to a target set then a join is required. A direct or inner join is implied when no rule or join is specified. The join is specified using related attributes. The relationship between the attributes is specified by giving them a common target attribute name. A single set can join within itself using separate attributes.

A named join allows for specification of other join types specified by Boolean logic. The name used for the join is unimportant as long as it is consistent within the map. The join type is specified as a rule. Sets that are associated with a join rule are considered subject to that rule. Join rules that apply to all source sets of a target set do not need to be directly associated with a source set and may be applied to the target set only. Examples of named joins are outer, exclusive, full etc.

### Example 3.a.i

### Inner Join

FIG. 12 provides an example of an inner join.

### Example 3.a.ii

### Optional (Outer) Join

As illustrated in FIG. 13, an optional join is where a specified set is included in the target set if it joins but does not exclude records from a driving set if it is not. The optional rule applies to the set that it is from and means that any intersection with this set will not exclude records from the target set if no record is found on the join. Intersections are specified as they are within an inner join. Any set that has no optional rule associated with it is considered a driver for the target set.

### Example 3.a.iii

### Exclude Join

As shown in FIG. 14, an exclude join is where the records that intersect from the exclusion set are excluded from the target set. Intersections are specified as they are within an inner join.

### Example 3.a.iv

### Cross Join

FIG. 15 provides an example of a cross join in which all members from cross joined sets are associated with all the members of the associated sets. This is specified by default if there are no commonly named target attributes between associated sets. A product of a cross join can be a target set with a large number of members. Where a cross is explicitly defined a cross rule can be specified on any or all sets.

### Example 3.b

### Non Equal Join

As illustrated in FIG. 16, joins that are not equal between attributes can have the comparator specified as a specified non equal join operator. The join operator is applied between the source attributes that have a common target attribute. The join is associated with the source set as it would be read from left to right. If a statement resolves with the source set associated with the join on the right, then the join condition must be reversed.

### Example 3.c

### Union

A union is a merging of multiple sets into one set where there is no join between the sets and the target set is a stack of source sets. Attributes with a common target name are aligned. Attributes that are missing for a set are set to empty (NULL). Where duplicate rows exist the duplicates are retained. The union rule may be associated with a target any number of times and need not be associated with a source.

### Example 3.c.i

### Union All

FIG. 17 provides an example of a union in which duplicate records are retained in the target set.

### Example 3.c.ii

### Union Distinct

As shown in FIG. 18, a distinct union operates the same as a union except duplicate records are eliminated from the target set. The distinct rule must be associated with a target set that is the target of a union.

### Example 4

### Data Reduction Primitives

### Example 4.a

### Limit

As illustrated in FIG. 19, a limit join rule specifies a restriction on the members of a set. This could be distinct entries, top 100, top 10% or any operation that declares a limiting treatment of a target set.

The distinct rule for instance eliminates duplicate records from the target set. The distinct rule must be associated with a target set and affects all members and attributes of the target set.

### Example 4.b

### Group

Rules may be associated with the group type, for example, as shown in FIG. 20. This type indicates that the rule is an aggregation of the members of an attribute that is associated with the rule. Attributes that are not associated with a rule of a group type represent what the target set is grouped by.

### Example 4.c

### Restriction

As shown in FIG. 21, complex inclusion conditions that involve logic which contain precedent or logical operators beyond an AND operator are handled using explicit restrictions. A rule of type restrict contains a logical expression which can be reused and requires no target attribute. If a target attribute is specified then the result of the logical expression is associated with the target attribute.

### Example 5

### Process Primitives

### Example 5.a

### Process Precedent

A process precedent is a rule that explicitly states that a set is dependent upon another set being populated without requiring any input from that set, for example, as shown in FIG. 22. This is useful for enforcing an order into set creation for timing reasons or external factors.

### Example 5.b

### Process Rule

As illustrated in FIG. 23, a process rule indicates that the target set is assigned the rule statement exactly without adding set and attribute creation statements. This is useful when process is required that is not part of the usual set creation stages. The process may be associated with a target set or source sets, the target set may be a result of the process.

### Example 5.c

### Loop

As shown in FIG. 24, a loop consists of a root set and which represents that initial contents of a target set and a loop set which is added to the target set for each loop until the loop set no longer produces any members. The root set is defined as a normal target set. The root set is associated to the target set using the loop rule. The attributes defined in the root set define the attributes in the target set. The target set is associated with itself forming the loop. The target set can be associated with other sets. An end condition to the loop should be specified otherwise the loop with continue indefinitely.

### Example

### The Mandelbrot Set

The following is a practical example of a map produced by the method of the invention used to represent an algorithm equating to the Mandelbrot set. The map has been rendered in the SQL language with the results plotted in a spreadsheet to provide the examples below.

The Mandelbrot set is a fractal represented by the formula: Z=Z²+C. The process of rendering this formula requires a number of stages. Each stage is represented by a set. FIG. 25 illustrates a Mandelbrot set process flow as defined by a map. In the figure, “Line:Range” represents the range for C, “Line” a linear series of numbers that equate to C, “Square” a two dimensional grid of x and y values with ranges that allow C to be expressed as X and Y coordinates, “Mandelbrot:Loop” applies the Mandelbrot set formula iteratively to each point within [Plot] and expresses the iteration that the point escapes the Mandelbrot set as a Z coordinate, and “Mandelbrot” takes the highest Z coordinate for each X and Y coordinate.

The result of the Mandelbrot set can be plotted in three dimensions. The flat area represents the coordinates that did not escape the Mandelbrot set.

### Mandelbrot Set—Stages in the Invention

The following breakdown of the process explains each set in the order that they are resolved which is resolved from the map based upon association. The rules are assumed to be in the T-SQL language.

### Line:Range

In the example shown in FIG. 26, set [Line:Range] has two attributes C and Max which represent the lowest value and maximum values of C respectively. The [Float] rule is a language specific rule to ensure that the attributes and any derived from them are represented within the computer as floating point numbers.

### Line

As shown in FIG. 27, set [L] represents the scale for C. [L] is populated by a loop that takes the set [L:Root] as the first iteration. For each iteration that follows C is set to the addition (the [Add] rule) by an increment (0.01 in this case) as long as the result is less than or equal to the value of [Max]. The value of [Max] is passed unchanged to the next iteration. The result of an iteration is passed to the next iteration as [L]. When no records are returned from an iteration then the loop is complete. The effect of this operation is that the set [L] has an attribute [C] which has all the values between −2.1 and 1.2 in increments of 0.01.

### Square

As illustrated in FIG. 28, set [Square] provides a grid of X, Y coordinates for C. The set [Line] is aliased as [X] and [Y]. The sets [X] and [Y] are then cross referenced into [Square] renaming the attribute [C] from the set [X] as [CX] for the X coordinate and renaming the attribute [C] from the set [Y] as [CY] for the Y coordinate.

### Mandelbrot:Loop:0

As illustrated in FIG. 29, set [Mandelbrot:Loop:0] takes the coordinates from plot and adds the values Pass, X and Y each initially zero. This is similar to the set [Line:Range] in that this set represents the first iteration of the set [Mandelbrot].

### Mandelbrot:Loop

As illustrated in FIG. 30, set [Fidelity] is a loop for which the first iteration is represented by the set [Fidelity:0]. The attribute [Pass] from set [Fidelity:0] starts at zero and increments by one until it reaches 50. A higher fidelity representation of the Mandelbrot set can be produced by increasing the number of passes. Attributes [CX] and [CY] are passed up through each iteration with attributes [X] and [Y] feeding into and becoming products of the rules [ZX] and [ZY]. [ZX] is [X²−Y²+C]. [ZY] is [2XY+C]. Each X, Y pair is considered to have escaped the Mandelbrot set when the product of rule [Escape] is greater than 16. [Escape] is [X²+Y²].

### Mandelbrot

The set [Mandelbrot] is a plot of the X and Y coordinates that originally came from the set [Square]. The maximum of attribute [Mandelbrot:Loop] for the coordinates before they escaped the Mandelbrot represents the Z coordinate. FIG. 31 illustrates a Mandelbrot set as defined by a map.

While some preferred aspects of the invention have been described by way of example, it should be appreciated that modifications and/or improvements can occur without departing from the scope of the invention as claimed in this specification.

The terms comprise, comprises, comprising, or comprised, if and when used herein, should be interpreted non-exclusively, that is, as conveying “consisting of or including”.

1. A computer-implemented method of generating or manipulating source code for a software development project, the method comprising:
generating a map comprising a first table having a plurality of cells arranged in three or more columns and one or more rows,
generating a second table having a plurality of cells arranged in two or more columns and one or more rows,
populating a cell in each table with an attribute from a set of attributes, wherein the cells are populated either by a user inputting an attribute or, automatically, by an attribute generated from an existing source code,
wherein a rule is applied to the attribute in a cell in each table and the application of the rule to the attribute automatically generates or manipulates source code.

2. The computer-implemented method according to claim 1, wherein a user can edit the attribute in a cell of each table and thereby change the source code.

3. The computer-implemented method according to claim 1, wherein the rule is expressed in a cell of the second table and a user can edit the rule and thereby change the source code.

4. The computer-implemented method according to claim 1, wherein a software system is divided into a plurality of stages, each stage being expressed in tabular form as a set of attributes.

5. The computer-implemented method according to claim 4, wherein each set of attributes is expressed as a collection of rows in a table, each row of which involves one or more transformations on the set of attributes.

6. The computer-implemented method according to claim 4, wherein two or more sets of attributes can be joined together as an input to a derived set of attributes.

7. The computer-implemented method according to claim 6, wherein an attribute in a cell of each table can be derived from a set of attributes, the results of the rule or the effect of a join between two or more sets of attributes.

8. The computer-implemented method according to claim 6, including associating rules which specify a type of join between two or more related sets of attributes that are used to derive a set of attributes.

9. The computer-implemented method according to claim 8, including defining a priority between the related sets of attributes that are used to derive a set of attributes.

10. The computer-implemented method according claim 8, including defining a non-equal relationship between the related sets of attributes that are used to derive a set of attributes.

11. The computer-implemented method according to claim 4, wherein the stages within a software system are derived from relationships between sets of attributes.

12. The computer-implemented method according to claim 1, wherein a staged process can be constructed from one or more of the rules to define a computer program in a language or collection of languages for which rules have been defined.

13. The computer-implemented method according to claim 12, wherein the staged process and the language specific rules can be deconstructed from a computer program.

14. The computer-implemented method according to claim 1, wherein one or more language fragments are reduced to rules which can be associated with a set of attributes.

15. The computer-implemented method according to claim 14, wherein one or more of the rules are embedded within one or more of the other rules.

16. The computer-implemented method according to claim 14, wherein one or more of the rules are associated with a language.

17. The computer-implemented method according to claim 12, wherein the staged process is associated with the rule.

18. The computer-implemented method according to claim 14, wherein the rule is associated with a rule type to apply common behaviour to a set of rules.

19. The computer-implemented method according to claim 14, wherein common terms within the rule are substituted with sets of attributes and attributes aliased during association.

20. The computer-implemented method according to claim 14, wherein rules are compared by name to discover variations of use for a common name.

21. The computer-implemented method according to claim 14, wherein rules are compared by language fragment to identify common usage patterns to allow for conformation of rules.

22. A computer program for generating or manipulating source code for a software development project, the computer program being configured to implement the method of claim 1.

23. The computer program according to claim 22, wherein the computer program is also configured to express algorithms in tabular form and apply one or more transformations against the algorithms.

24. The computer program according to claim 23, wherein the one or more transformations comprise one or more of the following:
decompiling the existing code into tabular form;
expressing an algorithm as a diagram of relationships;
compiling a table into the source code;
performing a pattern matching algorithm to identify common patterns within another transformation; or
rendering code in any language from tabular form.

25-28. (canceled)
